(19) United States
(12) Patent Application Publication
(10) Pub. No.: US 2015/0066744 A1
(43) Pub. Date: Mar. 5, 2015

(54) Apparatus and Method for Geolocation Based Content Delivery Fee Computation

(71) Applicant: Our Film Festival, Inc., San Francisco, CA (US)

(72) Inventors: Daniel Aronson, Berkeley, CA (US); Albert Reinhardt, Albany, CA (US); David Schweisguth, San Francisco, CA (US); Justin Nixon, San Francisco, CA (US); Jonathan Marlow, Brisbane, CA (US)

(73) Assignee: Our Film Festival, Inc., San Francisco, CA (US)

(21) Appl. No.: 14/019,377

(22) Filed: Sep. 5, 2013

(51) Int. Cl. G06Q 30/02

(52) U.S. Cl. CPC G06Q 30/0283
USPC 705/39; 705/400

(57) ABSTRACT

A computer implemented method includes receiving from a client device a request for content. A geolocation for the client device is identified. The delivery of the content to the client device is metered to form a metered content value. License terms for consumption of the content at the geolocation are identified. A licensing fee is computed based upon the metered content value and the license terms for consumption of the content at the geolocation.

### FIELD OF THE INVENTION

This invention relates generally to the distribution of content in computer networks. More particularly, this invention relates to techniques for geolocation based content delivery fee computations.

### BACKGROUND OF THE INVENTION

Content of all types may be distributed over a computer network. For example, content in the form of streaming video, photographs, written works, games, music and the like may be distributed over a computer network. It would be desirable to provide new mechanisms for content creators to distribute their works and for content consumers to have increased content options.

### SUMMARY OF THE INVENTION

A computer implemented method includes receiving from a client device a request for content. A geolocation for the client device is identified. The delivery of the content to the client device is metered to form a metered content value. License terms for consumption of the content at the geolocation are identified. A licensing fee is computed based upon the metered content value and the license terms for consumption of the content at the geolocation.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION OF THE INVENTION

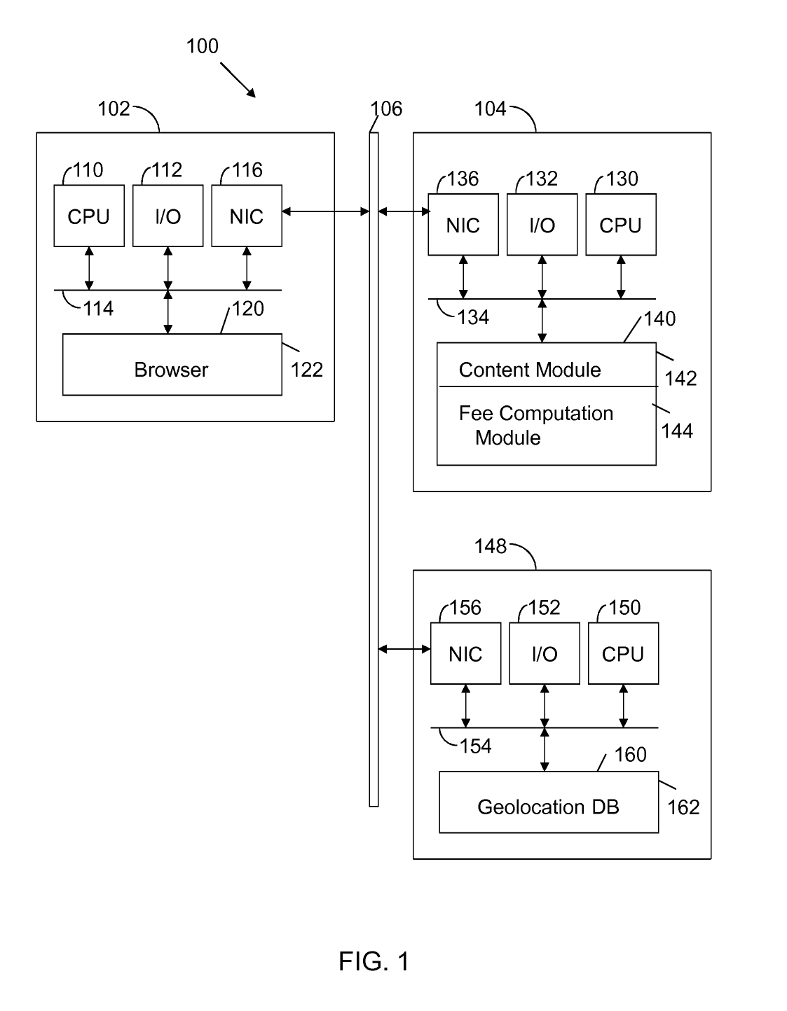

FIG. 1 illustrates a system 100 configured in accordance with an embodiment of the invention. The system 100 includes a client device 102 connected to a server 104 via a network 106, which may be any wired or wireless network or combinations thereof.

The client device 102 includes standard components, such as a central processing unit 110 connected to input/output devices 112 via a bus 114. The input/output devices 112 may include a touch display, a keyboard, mouse and the like. A network interface circuit 116 is also connected to the bus 114 to provide connectivity to network 106. A memory 120 is also connected to the bus. The memory 120 may store a browser 122, which may be used to access content over network 106. The client device 102 may be a desktop computer, a laptop computer, a tablet, a Smartphone, a game console, streaming media player, television and the like.

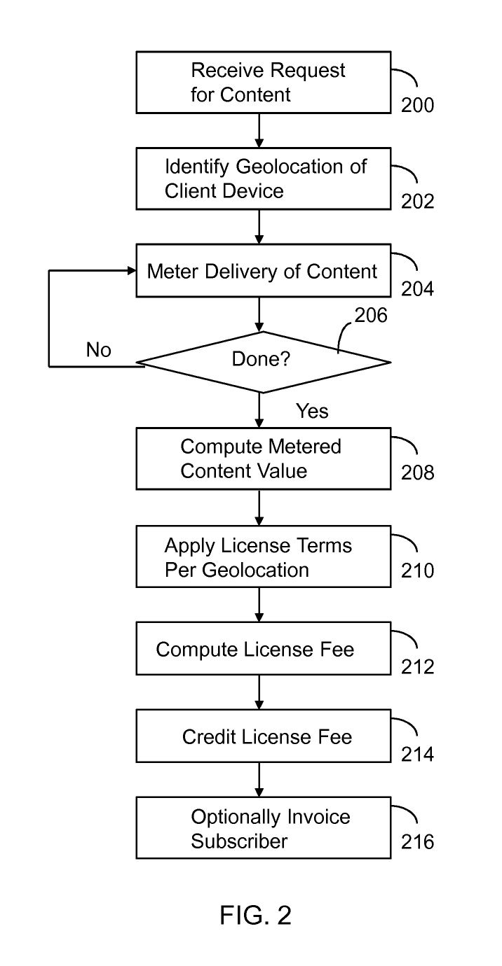

The server 104 also includes standard components, such as a central processing unit 130 and input/output devices 132 connected via a bus 134. A network interface circuit 136 and memory 140 are also connected to the bus 134. The memory 140 stores a content module 142. The content module includes executable instructions to display available content and deliver selected content to a requesting client device. A fee computation module 144 is also stored in memory 144. The fee computation module 144 includes executable instructions to implement operations of the invention, as discussed in connection with FIG. 2.

An additional server 148 may also be used in the system. The additional server 148 includes standard components, such as a central processing unit 150 connected to input/output devices 152 via a bus 154. A network interface circuit 156 and memory 160 are also connected to the bus 154. The memory 160 stores a geolocation database 162. The geolocation database 162 is accessible by other machines connected to the network 106. The geolocation database 162 may be implemented as a service which receives client information and returns a geolocation for the client device.

Geolocation is the identification of the real-world geographic location of an object. The location may be specified in geographical coordinates, but is preferably specified in a more human friendly form, such as an address, a county, a country and the like. Geolocation information may be obtained by looking up an internet protocol address through a WHOIS service to retrieve the registrant's physical address.

FIG. 2 illustrates processing operations associated with an embodiment of the invention. A request for content is received 200. For example, client device 102 may access content module 142 to request content. The request for content triggers the fee computation module 144 to identify the geolocation of the client device 202. A parameter associated with the client device (e.g., Internet Protocol (IP) address, Media Access Control (MAC) address, radio frequency identifier, hardware embedded article number, embedded software number, invoice, Wi-Fi positioning system, device GPS coordinates) may be passed to geolocation database 162 to obtain a geolocation. The geolocation may include information such as country, region, city, postal/zip code, latitude, longitude and time zone.

The delivery of the content is then metered 204. Checks 206 are periodically performed to determine whether the content delivery is completed or terminated. If not (206-No), additional content is metered. If so (206-Yes), a metered content value is computed 208. The metered content value may be in any number of units. For example, the metered content value may be time units specifying the amount of time transpired to deliver the content. The metered content value may be a data size metric. Any metric that provides granular information about delivered content may be used. Observe here that fractions of content may be measured and utilized in subsequent processing.

The next operation of FIG. 2 is to apply license terms per geolocation 210. That is, content license terms for consumption of content at the geolocation are looked up. Thus, an aspect of the invention addresses the problem of different content licensing terms applying for different geolocations. For example, content creators may have different licensing terms for domestic consumption versus foreign consumption, urban consumption versus rural consumption or other geolocation based distinctions.

The next operation of FIG. 2 is to compute a license fee 212. The license fee is computed based upon the metered content value and the license terms for consumption of the content at the geolocation of the client device. Observe here that the computation is based upon a metered value, which may be a fraction of the complete content. Further observe that the computation is dependent upon the geolocation of the client device.

The computed licensing fee may be based upon a single download of the content and therefore constitute a discrete transaction. Alternately, the licensing fee may be based upon a subscription fee to a content source. In this case, the user of the client device pays a subscription fee for a time period. The subscription fee allows the user to access all content at the content source. To compensate content creators that provide content that is more frequently accessed, a license fee may be computed that represents a fractional value of all subscriber fees. Computing a fractional value may include computing a curation component characterizing collective content of a content distributor as a fraction of all available content. Computing the fractional value may include computing a popularity component characterizing total consumption of the content as a fraction of total consumption of all available content. The fee may be computed immediately after content consumption. Alternately, the fee may be computed at pre-determined time (e.g., each day at midnight).

The next operation of FIG. 2 is to credit the license fee to the owner of rights to the content 214. The credit may be afforded in realtime or at a pre-determined time (e.g., each day at midnight). In one embodiment, the fee computation module 144 supports a variety of analytics that allow a content creator to observe license fee accumulation over time. Other analytics may include maps illustrating content consumption by geolocation. The maps may be based on total content consumption and/or time slices of content consumption.

The final operation of FIG. 2 is to optionally invoice a subscriber 216. This operation is performed in the case of a discrete transaction. Alternately, this operation may be performed in connection with a subscription, where for example, a user has access to some content for the subscription fee, but other content is paid for on a per download or fractional download basis.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
receiving from a client device a request for content;
identifying a geolocation for the client device;
metering delivery of the content to the client device to form a metered content value;
looking up license terms for consumption of the content at the geolocation; and
computing a licensing fee based upon the metered content value and the license terms for consumption of the content at the geolocation.

2. The computer implemented method of claim 1 wherein identifying includes accessing a networked internet protocol address database to retrieve a physical address for the client device.

3. The computer implemented method of claim 1 wherein the request for content is a request for streaming video.

4. The computer implemented method of claim 1 wherein the metered content value is in time units specifying the amount of time transpired to deliver the content.

5. The computer implemented method of claim 1 further comprising crediting the licensing fee to the owner of rights to the content.

6. The computer implemented method of claim 1 wherein computing a license fee includes computing a fractional value of all subscriber fees.

7. The computer implemented method of claim 6 wherein computing the fractional value includes computing a curation component characterizing collective content of a content distributor as a fraction of all available content.

8. The computer implemented method of claim 6 wherein computing the fractional value includes computing a popularity component characterizing total consumption of the content as a fraction of total consumption of all available content.

9. The computer implemented method of claim 1 further comprising computing a subscriber invoice for the metered content.

10. The computer implemented method of claim 1 further comprising supplying data characterizing license fee accumulation over time.

11. The computer implemented method of claim 1 further comprising supplying maps illustrating content consumption by geolocation.

12. The computer implemented method of claim 1 further comprising supplying maps illustrating total content consumption by geolocation.

13. The computer implemented method of claim 1 further comprising supplying maps illustrating time slices of content consumption by geolocation.
